(19) United States
(12) Patent Application Publication
(10) Pub. No.: US 2020/0371028 A1
(43) Pub. Date: Nov. 26, 2020

(54) BIOCIDE DETECTION

(71) Applicant: LUX ASSURE LIMITED, Edinburgh (GB)

(72) Inventors: Andrew OSNOWSKI, Edinburgh (GB); Scott RANKIN, Edinburgh (GB); Fiona CARSON, Edinburgh (GB); Mohsen ACHOUR, Bartlesville, OK (US); Emma PERFECT, Edinburgh (GB)

(21) Appl. No.: 16/636,205

(22) PCT Filed: Aug. 3, 2018
(86) PCT No.: PCT/GB2018/052236

§ 371 Date: Feb. 3, 2020

(30) Foreign Application Priority Data
Aug. 4, 2017 (GB) 1712580.8

(51) Int. Cl. G01N 21/64; G01N 21/77; G01N 31/22; G01N 21/39; G01N 1/40

(52) U.S. Cl. CPC G01N 21/643; G01N 21/77; G01N 2021/396; G01N 21/39; G01N 1/40; G01N 31/221

(57) ABSTRACT

A method and kit for the detection of biocide levels in a fluid conducting and containment system. Using micelle formation in the presence of a marker solution to determine if a biocide is at its effective dose throughout a fluid conducting and containment system.

The invention relates to a method of detecting biocides. More particularly, the invention relates to the detection of biocides in a fluid conducting and containment system used to screen, test, produce and process oil and gas, and their products.

Biocides are used in many industries to prevent bacterial growth on equipment and in products. One such industry is oil and gas production in which biocides are added to pipeline systems or facilities comprising a network of pipes used to screen, test, produce and process oil and gas, and their products. Biocides are used to preserve water quality in traditional, waterflood, storage and transport of water, as well as in fluids used in hydraulic fracturing. Biocide may be added continuously but it is more common to add a biocide periodically. As the portion of the fluid containing the biocide, often referred to as the ‘slug’, moves through the system it is degraded and/or consumed. Below a certain concentration (the ‘kill dose’) the biocide is no longer effective and any part of the system not receiving the kill dose will be at risk from microbial growth. Microorganisms are known to cause corrosion of oil and gas pipelines and facilities and it is therefore important to accurately determine the presence of the biocide throughout the system.

Biocides can comprise a number of different types of chemicals. Common biocides contain gluteraldehydes and/or quaternary amines. The amount of biocide added to a system will depend upon the volume of the pipelines forming the system the flow rate of the fluid within the pipeline, operating parameters including pH and oxygen levels, the type of biocide used and, if dosed periodically, how often it is dosed. Biocide treatments should also be reviewed and adjusted to ensure their dose is based on actual performance and it is therefore important to test for biocide downstream of injection to (i) evaluate if the dose was adequate to reach the full extent of the asset and (ii) to evaluate how quickly biocide is consumed. In a dirty system, more biocide is consumed so it is important to know whether to add more biocide and where; conversely, chemical costs can be optimized in a cleaner system if known biocide targets are achieved through the system. Systems may be considered “dirty” if they include oil and/or microorganisms and/or particulates.

It is difficult to provide a simple test on site that can detect these different chemicals used. Also, performing testing quickly on site is critical but due to the high volumetric flow of fluid and pipeline length, it is often difficult to precisely determine when the biocide ‘slug’ will arrive a the sampling point, leading to a missed opportunity unless samples can be taken and tested quickly.

Some of the known biocide detection methods are functional tests, and focus on whether the microbes in the system are alive or dead or inactive. These types of tests involve culturing, which is time consuming and can't be done on site; flow cytometry, which is complex and may not be able to differentiate between live and dead and inactive; ATP tests, which don't necessarily provide information on alive and dead, but inactive; and pH tests, and others.

Other known methods have used ‘tracers’ for detecting biocides, e.g. fluorescent tracers added at the same time as the biocide. At the point of sampling the concentration of the tracer is determined, and the amount related to the concentration of the biocide. However, the accuracy of these types of tests may be hindered by interference from other fluorescing entities in the fluid e.g. oil. An example of this kind of test is described in U.S. Pat. No. 5,702,684. This method has the disadvantage drat it requires addition of chemical compounds not usually found in a pipeline Which may cause unforeseen changes to the composition of the fluid leading to unrepresentative data

Biocides may be tracked through a system by tagging them with fluorescent moieties, meaning they can be detected directly. However, this raises the costs of chemicals and it can be difficult to differentiate the fluorescent moiety from naturally occurring fluorescence of systems, for example from hydrocarbons and/or algae in samples.

Alternately, biocides may be detected directly if they have an inherent fluorescent signature (EP0614079 A2). Again this suffers from interferences in field fluids meaning an accurate measurement of the active organic species may not be obtained.

Wet chemical analysis methods may be used e.g. High Performance liquid chromatography (HPLC) or liquid chromatography-mass spectrometry (LC-MS). These are time consuming, labour intensive, and complex techniques which are rarely used in the field.

Methods exist to quantify the levels of biocides containing aldehydes through chemical reaction with the biocide e.g. through the Hantzsch reaction. These methods may also include fluorescent detection, see for example WO2015161020 A1. These methods suffer from error in that there may be cross reactions, or interferences with the reaction.

In other methods, for example WO2015/138036, biocides may be detected by adding fluorescent dyes to react to biocides comprising cationic additives. Again this type of reaction can suffer interferences.

It is an object of the invention to seek to mitigate problems such as those described above.

According to a first aspect of the invention there is provided a method of detecting biocides in a fluid conducting and containment: system comprising a) adding a micelle forming biocide to the system, b) sampling the fluid from one or more parts of the system downstream of biocide injection at-line, on-line, or offline and adding a marker solution containing an optically detectable marker to the sample that discloses the presence of micelles c) detecting an optical signal from the marker solution in the presence of micelles d) if no micelles are detected, adding an additional surfactant-containing chemical to the sample before, at the same time as, or after the marker solution until a micelle-related signal is generated, and e) determining the presence of the biocide in the sample. This method has the advantages of timely detection of biocide residuals to allow better management, minimise microbial problems, and avoiding using unnecessary excess of biocide for cost savings and environmental benefit. The method allows for the determination of the dose of the biocide through the detection of micelles in the original sample without the need for additional detection steps. This is advantageous when results are required quickly at oil and gas pipeline systems or facilities comprising a network of pipes used to screen, test, produce and process oil and gas, and their products. The micelle forming biocide forms a detectable level of micelles in the system and may be a micelle forming surfactant biocide.

Preferably, where the critical micelle concentration (CMC) of the biocide is unknown, the first aspect further comprises the step of determining the CMC for the biocide being added to the system prior to step a). More preferably, the first aspect: further comprises the step of determining the minimum kill dose of the biocide prior to step a). Even more preferably, the first aspect further comprises the step of determining how the minimum required kill dose of the biocide is related to the critical micelle concentration. This step can also be done prior to step a). Determining how the minimum required kill dose of the biocide is related to the critical micelle concentration allows a user to understand the correlation between micelle formation and the effectiveness of the biocide. Therefore, the critical micelle concentration can be used to determine the level of the biocide in a fluid.

Preferably, if the minimum required kill dose of the biocide is below the critical micelle concentration, the first aspect further comprises the step of adding to the sample an additional micelle forming surfactant-containing chemical until a micelle-related signal is detected. More preferably, the minimum required kill dose of the biocide in the sample taken from the fluid is determined using the amount of additional micelle forming surfactant-containing chemical added to the sample. Once the relationship between the minimum kill dose of the biocide and the critical micelle concentration has been determined, it can be used to determine the level of the biocide in the fluid. The amount of micelle forming surfactant-containing chemical added to the sample before micelles are detected is used to assess the level of the biocide in the fluid. Therefore, from this information, it is possible to determine if the biocide in the fluid is at the minimum kill dose at the points in the system where samples were taken, or if not, what level is present in the sample.

Preferably, the additional micelle forming surfactant-containing chemical is the biocide added to the system in step a). This is advantageous as adding new chemicals to the sample may have unexpected consequences, for example, they may have different partitioning effects, and this may lead to inaccurate results.

Preferably, the fluid conducting and containment system is a system used to screen, test, produce and process oil and gas, and their products. These systems are particularly at risk of corrosion due to microbial growth and it would be highly beneficial to have a quick and effective method for determining if a biocide is at its minimum kill dose at all points in the system.

Preferably, the method further comprises the step of optimizing the further addition of biocide in order to maintain an effective concentration to maximize protection and minimize the overuse of the chemical by using micelles to indicate presence of chemical. in the fluid.

Preferably, the method of the first aspect further comprises the step of producing a biocide map of the fluid conducting and containment system. Mapping the levels of the biocide throughout the system is advantageous as it will show which parts of the system are most at risk from microbial growth and if an alternative biocide distribution strategy is required.

Preferably, the method of the first aspect of the invention further comprises the step of preparing at least one control sample. Control samples may be used to assess the fluid and ensure representative data.

Preferably, salt is added to at least one of the control samples in order to assess the ionic strength of the sample. This is advantageous as it ensure micelles can be created anti there is not an issue with the fluid being of low ionic strength, the term salt may refer to sodium chloride, but may also refer to any salt that changes the ionic strength of the samples.

Preferably, an additional micelle-forming chemical is added to at least one of the control samples in order to assess if the sample contains a component that prevents the formation of micelles. Preferably, the additional micelle-forming chemical is a surfactant. This is advantageous as it ensures that there is nothing in the fluid that prevents micelle formation.

According to a second aspect of the invention, there is provided a kit for performing the method of the first aspect of the invention comprising at least one marker solution containing an optically detectable marker. In some embodiments the kit may further comprise positive and negative controls, reference standards, a means to measure transmission of samples, a means to measure pH of samples, a means to filter samples, a means to centrifuge samples. In other embodiments, the kit may further comprise instructions for performing the method and/or a micelle forming surfactant-containing chemical.

In the context of this invention, the term downstream means situated or moving in the direction in which the fluid flows and, in some embodiments, may refer to parts of a pipeline situated after an oil or gas well head or ‘Christmas tree’ in the direction of fluid flow, i.e, downstream of the site of injection of the biocide into the system.

The invention will be further described with reference to the drawings and figures, in which:

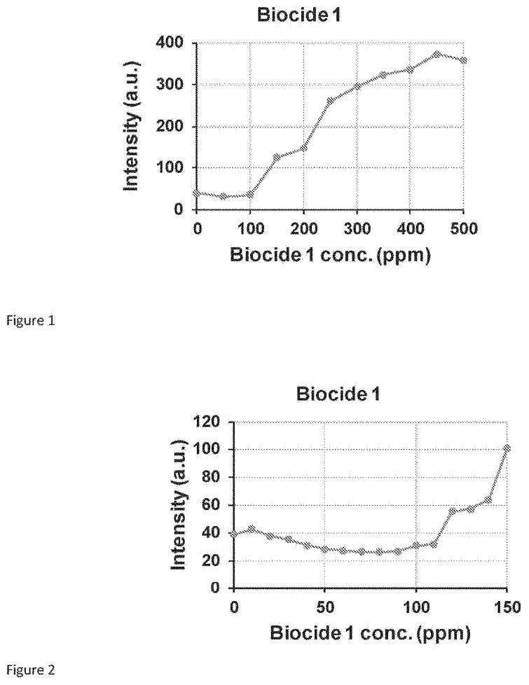

FIG. 1 shows a graph of optical signal intensity verses biocide 1 from 0-500 ppm;

FIG. 2 shows a graph of optical signal intensity verses biocide 1 from 0 to 150 ppm;

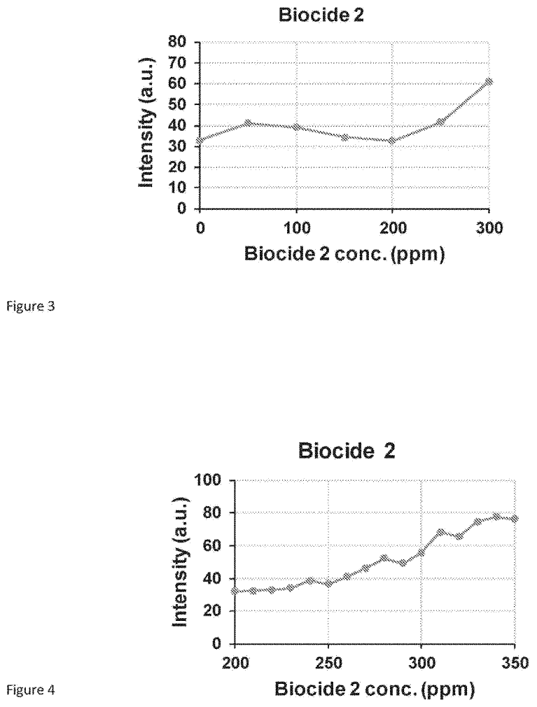

FIG. 3 shows a graph shows a graph of optical signal intensity verses biocide 2 from 0-300 ppm;

FIG. 4 shows a graph of optical signal intensity verses biocide 2 from 200 to 350 ppm;

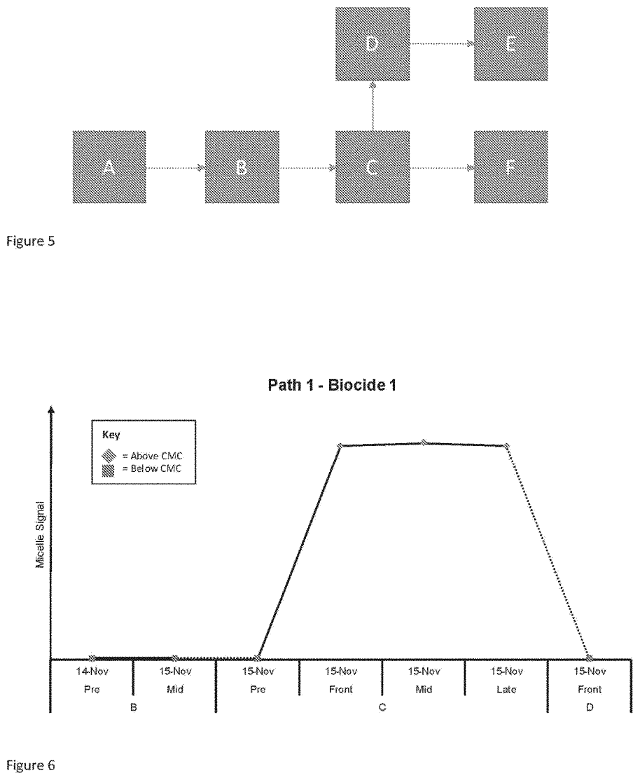

FIG. 5 shows a field map of a representative example of a fluid conducting and containment system;

FIG. 6 shows a graph of the micelle detected in section of the system shown in FIG. 5 downstream from the CPF1 inlet after dosing with biocide 1;

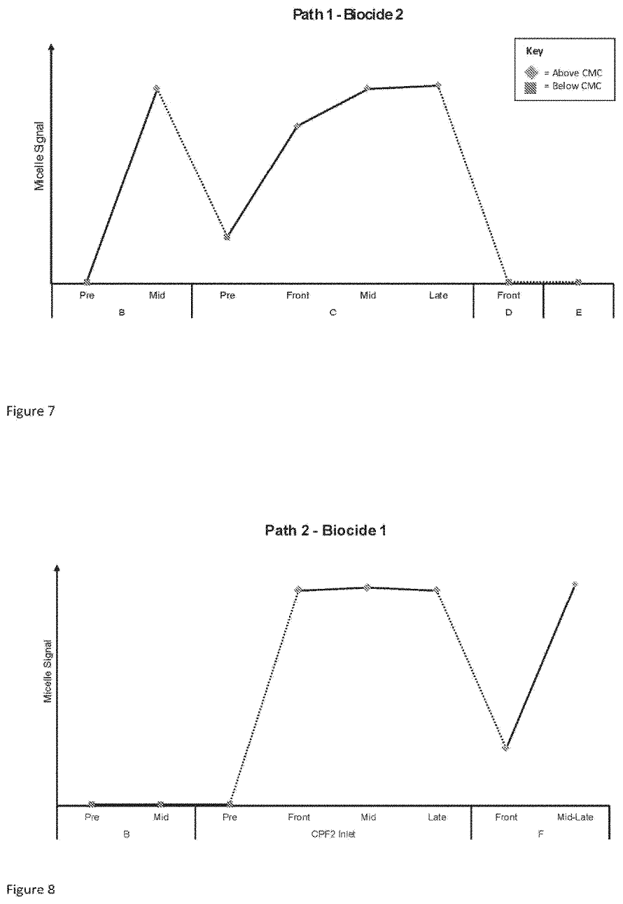

FIG. 7 shows a graph of the of micelle detected in section of the system shown in FIG. 5 downstream from the CPF1 inlet after dosing with biocide 2;

FIG. 8 Shows a graph of the of micelle detected in section of the system shown in FIG. 5 downstream from the CPF2 inlet after dosing with biocide 1;

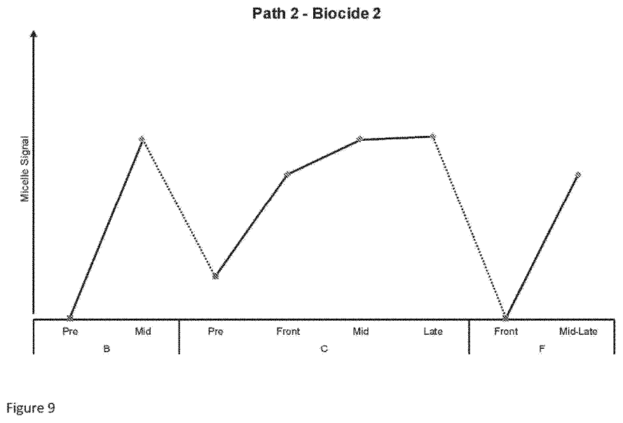

FIG. 9 shows a graph of the of micelle detected in section of the system shown in FIG. 5 downstream from the CPF2 inlet after dosing with biocide 2; and

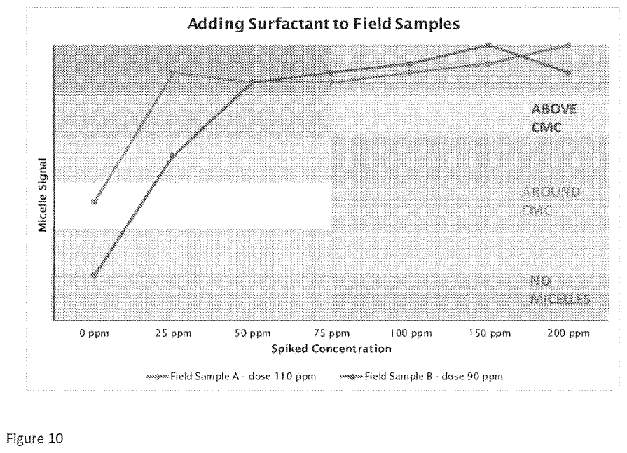

FIG. 10 shows a graph of the results from adding additional biocide to enable micelle detection in two oil and gas processing facility field samples.

### EXPERIMENT. A: DETECTION OF BIOCIDE 1 IN THE LABORATORY

Biocide 1 is used in an oilfield system to control bacterial growth and is an aqueous mixture of ca. 40% alkyl*-1,3-propylene-diamine acetate (*Coco) and 20% isopropanol. It is batch dosed at 1 week intervals at a concentration of 300 ppm. The active components of Biocide 1 consist of cocodiamine. Testing was conducted in the lab to determine if Biocide 1 could be detected, prior to any testing in the field. Testing in the lab occurs in a much less challenging environment than the field and so positive results at this stage do not guarantee successful detection will be possible in the field.

A range of concentrations of Biocide 1 were prepared which bracketed the field dose concentration. A .1% stock solution (10,000 ppm) of Biocide 1 was prepared in deionised water by dilution of 1000 mg of neat biocide to the graduated mark on a 100 mL volumetric flask. The solution was gently inverted to ensure homogenous mixing and stored at 2.1° C. when not in use. A concentration series of chemical, in 50 ppm increments, between 0 and 500 ppm was prepared by dilution of 0, 25, 50, 75, 100, 125, 150, 175, 200, 225, 250 μL of 1% stock to 5 mL with the supplied field water sample. A second concentration series incorporating concentrations between 0 and 150 ppm was formulated by dilution of 0, 5, 10, 15, 20, 25, 30, 35, 40, 45, 50, 55, 60, 65, 70 and 75 μL of 1% stock to 5 mL with field water. Each sample was transferred to a cuvette and Nile Red added to a volume of 1%; the fluorescent signal was then measured. FIG. 1 shows the signal for 0-500 ppm samples and a large increase in signal occurs at 100-150 ppm; this is the concentration where micelles start to form (CMC). The narrower range of concentrations allowed a more accurate determination of the CMC and this testing indicated the CMC was 110-120 ppm (FIG. 2). These results showed that Biocide 1 is detectable at concentrations of 120 ppm and above under laboratory testing conditions.

### EXPERIMENT B. DETECTION OF BIOCIDE 2 IN THE LABORATORY

Biocide 2 is used in the same oilfield system described in Experiment A and is also batch dosed at 1 week intervals. Biocide 2 is an aqueous mixture of 42.5% glutaraldehyde,7.5% n-Alkyl dimethyl benzyl ammonium chloride, with less than 1% ethanol and methanol. It is dosed at a concentration of 1000 ppm and contains 6% of a quaternary amine surfactant with the major constituent biocide being glutaraldehyde (50%). A 1% stock solution of Biocide 2 was prepared in deionised water by dilution of 1000 mg of neat inhibitor to the gradated mark on a 100 mL volumetric flask. The solution was gently inverted to ensure homogenous mixing and stored at 21° C. when not in use. A concentration series between 0 and 300 ppm was prepared at 50 ppm increments in field water in an identical fashion to that described for Biocide 1 in Experiment A. A second concentration series between 200 and 350 ppm, at 10 ppm increments, was prepared by dilution of the 1% stock (0, 25, 50 . . . 175 μL) to 5 mL in field water. Each sample was transferred to a cuvette and Nile Red added to a volume of 1%; the fluorescent signal was then measured. FIG. 3 shows the signal for the 0-300 ppm samples and ate increase in signal occurs at 200-250 ppm; this is the concentration where micelles start to form (CMC). The narrower range of concentrations allowed a more accurate determination of the CMC and this testing indicated the CMC was 240-260 ppm (FIG. 4). These results showed that Biocide 2 is detectable at concentrations of 250 ppm and above under laboratory testing conditions.

### EXPERIMENT C: DETECTION OF BIOCIDE 1 IN THE FIELD

Biocide 1 is batch dosed into a very complex oilfield system which contains lots of interconnecting pipelines. The biocide is injected over a period of 3 h and is expected to help control bacterial growth throughout that system. To do this it is important it reaches the furthest points in the system.

A map of the system (FIG. 5) along with prior knowledge of fluid transit times was used to design a testing regime whereby samples were collected during the time the biocide was expected to pass each sample point. The samples were collected in HDPE containers and a small aliquot transferred to a cuvette. Nile Red was added to a tiolume of 1%; the fluorescent signal was then measured.

FIGS. 6-9 show the results from the analysis of the samples. Pre, Front, Mid and Late refer to the estimated time passage of the biocide slug. The data indicated that the biocides were not reaching the furthest point in the system which is important information as it could mean this area is partially or fully unprotected. Testing of a different branch of the system showed that biocide 1 was present at detectable levels. The results showed that the biocides could be tracked through the system and that this method is a quick and easy way to determine if biocide is reaching points in the system to a level above the CMC.

The level above which the biocide needs to be present to be effective is known as the kill, level. For Biocide. 1 the kill level concentration was around the same concentration as the CMC, therefore using a method to detect biocide presence above the CMC also provides information about the chemical being present at or above the effective dose which is important information to have, to allow control of bacterial growth.

Several samples contained oil and it was not clear what effect this would have on biocide analysis. The oil could interfere with (i) the fluorescent signal, (ii) the formation of micelles, for example due to partitioning or (iii) Nile Red used to disclose the micelles. The oil was actually found to have very little effect on the results with the oil-containing fluids giving comparable signals to the non-oil-containing fluids.

FIG. 10 shows the results from spiking surfactant into field samples to estimate the concentration of surfactant originally present.

### EXPERIMENT D: ADDING MICELLE FORMING SURFACTANT TO SAMPLES CONTAINING BIOCIDE 2 TO ENABLE MICELLE DETECTION

For Biocide 2 the kill level concentration was below the CMC, due to the primary active component being non-micelle forming glutaraldehyde and a minor component being micelle forming quaternary amine. In the field, therefore, the presence of micelles in a sample will indicate adequate/overdosing, but their absence does not necessarily indicate that the fluid is inadequate (below kill dose). In this circumstance, additional micelle forming chemical, either the actual biocide used or another chemical, can be spiked into the sample, accordingly to the difference between kill dose and CMC, and preferably at a range of other concentrations to indicate how far below a kill dose the sample may be.

The critical Micelle concentration of commercially available biocide 2, which contains 6% of a quaternary amine surfactant with the major constituent biocide being glutaraldehyde (50%). was determined to be ˜190 ppm in 1M NaCl. 80-180 ppm samples of the biocide were prepared and then spiked with various amounts of biocide. The point at which micelles formed in these spiked samples was recorded. The results in Table 1 show a good match for all samples i.e. the amount of chemical added plus the original concentration in the sample equalled the CMC determined for the chemical at the outset.

TABLE 1

| Base conc. | Spike conc. of | Total conc. | Calculated CMC |
|---|---|---|---|
| (ppm) | micelles (ppm) | (ppm) | (ppm) |
| 100 (Day 1) | 96 | 196 | 190 ± 10 |
| 130 (Day 1) | 65 | 195 | 190 ± 10 |
| 160 (Day 1) | 34 | 194 | 190 ± 10 |
| 180 (Day 1) | 9 | 189 | 190 ± 10 |
| 80 (Day 2) | 117 | 197 | 190 ± 10 |
| 140 (Day 2) | 55 | 195 | 190 ± 10 |

In one embodiment, surfactant based biocides, for example quaternary amines, are used in the system. Therefore the micelles wilt be formed in the fluid and can be detected. However, in an alternative embodiment the biocide composition used in a pipeline may be formed from more than one type of biocide compound. Therefore, a surfactant based biocide may be a minor component and an additional active species which is non micelle forming may be a major component, for example glutaraldehyde. Micelle formation may not be observed at the kill dose and micelle presence may not be anticipated in the sample

In this embodiment, the presence of biocide may be determined by adding a micelle forming surfactant to the sample until micelles are detected. The surfactant added to the sample is preferably the surfactant biocide that forms the minor component of the biocide composition. Different chemicals may have different partitioning effects and using a known surfactant biocide already routinely used in the system would avoid unforeseen issues.

The surfactant can be used to determine the presence, level, flow and consumption of biocides containing non-surfactant active component. From this it is possible to determine the kill dose of the biocide.

Commonly used biocides include: oxidisers e.g. chlorine, bromine, hypochlorite and ozone; poisons including aldehydes e.g. glutaraldehyde, amines e.g. cocodiamine and quaternary amines, sulfur-containing compounds e.g.; and other chemicals such as tetrakis hydroxymethyl phosphonium sulfate (THPS), 2,2-dibromo-3-nitrilopropionamide (DBNPA). Surfactants are often found in biocide formulations to assist in penetrating and dispersing biofilms. They can be extremely valuable in treating biofilms in oil-containing systems and so in determining overall effectiveness. Their use needs to be carefully managed as they can lead to unwanted operational side effects, such as foaming or emulsions.

Micelles may be detected indirectly using interfacial tension, which identifies the critical micelle concentration. This is not suitable for oil field fluids. It may be possible to image large aggregates of micelles by conventional light microscopes if they are large enough (i.e. greater than the Abbe limit of about 0.5 μm), although individual micelles tend to be in the nm scale. Alternatively, in other embodiments, a compound capable of associating with a micelle to produce an amplified or detectable signal may be added.

A marker solution may be added to the sample which creates or enhances a detectable property (e.g. fluorescence err luminescence). The optical signal produced by the marker solution in the presence of micelles can then be detected.

The marker may contain phenoxazone dyes, dialkylcarbocyanines or pyridium betaine dyes.

The optical signal may be amplified when associated with the micelle relative to the disassociated state and therefore increases the signal to noise ratio resulting in increased overall :sensitivity. The alteration in signal might, for example, result from a change in the electronic environment of the marker molecule which varies the molecular dipole moment in the ground and excited states. These differences result in a relative modification of the quantised energy of light absorbed or emitted in spectroscopic processes and so can be measured experimentally, for example through absorption, transmission, fluorescence intensity, fluorescence wavelength, fluorescence polarisation or fluorescence lifetime.

In other embodiments, the signal may be colourometric, absorbance/transmission, luminescent or fluorescent.

Micelles have distinct optical properties of shape and light diffusion, diffraction and reflection which allow them to be discriminated from other particles. Smaller particles may be imaged beyond the diffraction limit using, for example, dark-field imaging and/or Brownian motion analysis.

Another method that may be used for detecting and analysing the micelles is spectral analysis (spectroscopy). In complex fluids, such as those from oilfield production, there are likely to be many different types of particles with origins which must be discriminated against in the analysis. One method of achieving this is by interrogating the analyte with light and recording the resulting spectral properties of the system. In one embodiment this may involve recording the bulk UV, visible or infrared absorption of light at a certain wavelength. The resulting absorption, either with or without the addition of a marker solution, may be indicative of the presence of micelles. Alternatively, fluorescence emission, lifetime or polarisation could be used.

In an expansion on this, spectral resolution can be combined with an imaging system so that each recorded pixel will contain spectral information rather than just intensity. For example, fluorescence imaging can be used to measure the colour of the fluorescence emission, the colour emitted in response to the presence of biocide being different from the colour emitted in response to the presence e.g, oil, sand or other additives. Those methods can be broadly termed as spectral or hyperspectral imaging. In one embodiment, the spectrum imaged may just be a simple recording at three different wavelengths e.g. RGB, or it could include a full spectral scan across e.g. 500-900 nm.

Diffraction technologies may also be used to detect and monitor the micelles. Systems for measuring nano-particles involving light scattering or diffraction techniques may be used to determine the particle size of the micelles in solution and also the properties of those particles. In its simplest form the diffraction of light resulting from suspended particles in solution can be used to determine the presence, average particle size and the relative distribution of particles in the solution. Addition of supplementary sensing technology such as interferometry, impedance and zeta potential measurements can additionally characterise the system to provide discrimination between micelles and interfering species.

Other methods for detecting and monitoring micelles formation are based on particle interrogation and counting systems. For example, flow cytometry is a method of examining and sorting microscopic particles in a fluid. These systems are built to varying specifications and record parameters including particle volume, shape, size etc. They are often also associated with fluorescence detection in microbiological studies and combine this with light scatter analysis in systems such as a Fluorescence-Activated Cell Sorter (FACS). Such a device could be modified to measure micelles and other particles in material to provide a rich pool of data. Because micelle detection requires no antibody binding step the analysis would also be much faster than traditional flow cytometry and he amenable to on-site use.

Useful information may be obtained from monitoring micelle formation. In addition, analysis of the micelles (e.g. assessment of their presence, number, size and shape) will provide information on the physico-chemical properties of the fluid.

In the present method, a fluid sample may be monitored “at-line”, “off-line”, “on-line”.

An “off-line system” allows the user to take a sample from a system, and analyse it at a later stage. Such a system is useful if the equipment for analysis is located far from the location at which the sample is taken. It can also provide the user with a method for collecting samples taken at various time points and then analysing them to produce data showing composition relative to time.

An “at-line system” allows the user to remove a sample from the system and analyse it on site. For example, the user could remove the sample with a syringe through a needle port, mix it with a detection molecule, mount on a microscope slide and analyse the signal. A portable fluorescence spectrophotometer may also be used for the detection step. This system is not real time but is rapid, and all of the equipment is portable and may be automated, making this method of testing suitable for both offshore use and onshore production operations, refining, etc.

An “on-line system” may be a automated monitoring system, which feeds directly into a computerised system for monitoring offsite. For example, an on-line system may incorporate an automated in-line system, information from the in-line system being relayed directly to the operator's computer system so that it may be reviewed by technicians at a different location. This method advantageously allows data to be recorded in real time, but the personnel required to analyse the data would not need to be on-site.

The fluid may be sampled at-line, on-line, or off-line either before or after addition of the marker solution, i.e. sampling of the fluid may occur from one or more parts of the system at-line, on-line, or off-line and then a marker solution added to the sample or a marker solution containing an optically detectable marker may be added to the fluid and then the fluid sampled from one or more parts of the system at-line, off-line, or on-line. In the embodiment in which the marker solution is added to the fluid prior to sampling, the marker solution may be added at the time of adding the biocide or at one or more locations downstream of the location the biocide was added to the system.

1. A method of detecting biocides in a fluid conducting and containment system comprising:
a) adding a micelle forming biocide to the system;
b) sampling the fluid from one or more parts of the system, at-line, on-line, or off-line and adding a marker solution containing an optically detectable marker to the sample that discloses the presence of micelles;
c) detecting an optical signal from the marker solution in the presence of micelles;
d) if no micelles are detected, adding an additional micelle forming surfactant-containing chemical to the sample before, at the same time as, or after the marker solution until a micelle-related signal is generated; and
e) determining the presence of the biocide in the sample.

2. The method according to claim 1, further comprising the step of determining the critical micelle concentration for the biocide being added to the system prior to step a).

3. The method according to claim 1, further comprising the step of determining the minimum kill dose of the biocide prior to step a).

4. The method according to claim 3, further comprising the step of determining how the minimum required kill dose of the biocide is related to the critical micelle concentration.

5. The method according to claim 4, wherein if the minimum required kill dose of the biocide is below the critical micelle concentration, then further comprising the step of adding to the sample an additional micelle forming surfactant-containing chemical until a micelle-related signal is detected.

6. The method according to claim 5, wherein the minimum required kill dose of the biocide in the sample taken from the fluid is determined using the amount of additional micelle forming surfactant-containing chemical added to the sample.

7. The method according to claim 5, wherein the additional micelle forming surfactant-containing chemical added to the sample is the biocide added to the system in step a).

8. The method according to claim 1, wherein the fluid conducting and containment system is a system used to screen, test, produce and process oil and gas, and their products.

9. The method according to any one of the preceding claim 1, wherein the method further comprises the step of optimizing the further addition of biocide to the fluid in the system in order to maintain an effective kill dose in order to maximize protection and minimize the overuse of the chemical by using micelles to indicate presence of chemical in the fluid.

10. The method according to claim 1, wherein micelles formation is measured using laser diffraction, interferometry or imaging, spectroscopic means, hyperspectral imaging or flow cytometry.

11. The method according to claim 1, further comprising the step of producing a biocide map of the fluid conducting and containment system.

12. The method of claim 1, wherein the fluid comprises one or more of water, oil, solids, gas, liquefied gas and/or emulsions.

13. The method according to claim 12, wherein the monitoring micelles presence in the fluid comprises monitoring micelles formation in water.

14. The method according to claim 1, wherein micelle formation is monitored using optical means.

15. The method according to claim 8, wherein micelles formation is monitored using laser diffraction, interferometry or imaging, spectroscopic means, hyperspectral imaging or flow cytometry.

16. The method according to claim 1, wherein sampling is performed at one or more locations in the system.

17. The method according to claim 1, further comprising the step of preparing at least one control sample.

18. The method according to claim 17, wherein salt is added to at least one of the control samples in order to assess the ionic strength of the sample.

19. The method according to claim 17, wherein an additional micelle-forming chemical is added to at least one of the control samples in order to assess if the sample contains a component that prevents the formation of micelles.

20. A kit for performing the method of claim 1 comprising:
at least one marker solution containing an optically detectable marker.

21. The kit according to claim 20, further comprising:
positive and negative controls.

22. The kit according to claim 20, further comprising:
reference standards.

23. The kit according to claim 20, further comprising:
a means to measure transmission of samples.

24. The kit according to claim 20, further comprising:
a means to measure pH of samples.

25. The kit according to claim 20, further comprising:
a means to filter samples.

26. The kit according to claim 20, further comprising:
a means to centrifuge samples.

27. The kit according to claim 20, further comprising:
instructions for performing the method.

28. The kit according to claim 20, further comprising:
a micelle forming surfactant-containing chemical.
